(19) United States
(12) Patent Application Publication
(10) Pub. No.: US 2006/0181839 A1
(43) Pub. Date: Aug. 17, 2006

(54) Display module of mobile body, panel unit and image control unit for use in the same

(75) Inventor: Tadashi Yamada, Matsumoto-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/352,998

(22) Filed: Feb. 14, 2006

(30) Foreign Application Priority Data
Feb. 15, 2005 (JP) 2005-037299
Feb. 15, 2005 (JP) 2005-037300
Jan. 24, 2006 (JP) 2006-015360

(51) Int. Cl. H02B 1/01

(52) U.S. Cl. 361/627

(57) ABSTRACT

A display module of a mobile body includes a plurality of panel assemblies each having an electroluminescent panel. In the display module of the mobile body, one of mobile body information data and image data is displayed on each electroluminescent panel of the plurality of panel assemblies.

### BACKGROUND

1. Technical Field

The present invention relates to a display module for a mobile body, which is mounted on the mobile body, such as a vehicle, aircraft, ship, electric train and so on, for displaying a speed of the mobile body, the number of revolutions of an engine of the mobile body, map information of a navigator installed in the mobile body, etc, and a panel unit and an image control unit for use in the display module.

2. Related Art

Conventionally, it has been known that an information displaying device mounted on an instrument panel of a vehicle displays a plurality of images on one screen (multi-display device) composed of a liquid crystal display device (see JP-A-2004-291731). Such an information displaying device for vehicle employs one liquid crystal panel. In this liquid crystal panel, three kinds of displays are conducted by a first display unit as a speedometer for indicating a speed of the vehicle, a second display unit as a tachometer for indicating the number of revolutions of an engine of the vehicle, and a third display unit for displaying map information of a car navigator.

However, since the conventional information displaying device for vehicle disclosed in JP-A-2004-291731 is configured to display the plurality of images on one liquid crystal panel, the problems are as follows:

An available area used for actual display in a display area of one liquid crystal panel is half the display area. Like this, although only a portion of the display area of the liquid crystal panel is used, a driving circuit operates to scan the overall display area, including a non-use area. This results in a slow data transfer rate as well as wasteful power consumption. Also, a percentage of the number of available pixels is small.

Since the liquid crystal panel is large, a yield is poor. This is because, when a plurality of large liquid crystal panels are taken from one large panel, a probability that defects of pixels occur in individual liquid crystal panels becomes high, and hence, the number of panels to be obtained from one large panel decreases.

### SUMMARY

An advantage of some aspects of the invention is that it provides a display module of a mobile body, which is capable of displaying images with reduced power consumption, increased data transfer rate and increased yield, and a panel unit and an image control unit. for use in the display module.

According to an aspect of the invention, a display module of a mobile body includes a plurality of panel assemblies each having an electroluminescent panel. One of mobile body information data and image data is displayed on each electroluminescent panel of the plurality of panel assemblies.

With this configuration, images of a different display type can be displayed simultaneously by each of the plurality of electroluminescent panels. For example, when the plurality of electroluminescent panels is mounted on an instrument panel of a vehicle, different images such as a speedometer, a tachometer, an image of a television, map information of a car navigator, etc. can be displayed simultaneously by the plurality of electroluminescent panels. In addition, various image data may be changed to display different images by each of the plurality of electroluminescent panels. In addition, since different images are displayed by the plurality of electroluminescent panels, wasteful power consumption of each panel may be reduced, while increasing a data transfer rate. In addition, a percentage of the number of available pixels increases. In addition, yield of the electroluminescent panels increases. This is because a size of each electroluminescent panel becomes small, and therefore, when a plurality of electroluminescent panels are taken from one large panel, a probability that defects of pixels occur in individual electroluminescent panels becomes low, and hence, the number of panels to be obtained from one large panel increases, as compared to the conventional technique in which a plurality of displays is conducted in one liquid crystal panel. In addition, since each panel is the electroluminescent panel, contrast is high and display with good visibility is possible. Accordingly, with the reduction of power consumption, the increase of the data transfer rate and the increase of the yield, a display module of a mobile body enabling display of different images can be realized.

For example, if the mobile body is a car, the mobile body information data used herein means car information data, such as a car speed or an engine revolution number, indicating driving information of the car. In addition, the image data used herein includes image data from other systems, such as a car navigator, a television, a video apparatus, etc., installed in a car, or image data from a storage device such as an HDD, DVD, etc.

In the display module, each of the plurality of panel assemblies includes a panel control board provided with a panel control circuit for displaying a plurality of display image data prepared on the basis of the mobile body information data and the image data displayed on each electroluminescent panel. With this configuration, the mobile body information data such as the car speed or the engine revolution number and the image data such as the map information of the car navigator can be simultaneously displayed by each of the plurality of electroluminescent panels.

The display module may further include an image control board provided with an image processing circuit for preparing the plurality of display image data on the basis of the mobile body information data and the image data to be input and outputting the prepared display image data to each panel control circuit of the plurality of panel assemblies. With this configuration, display in the plurality of electroluminescent panels can be controlled at the image control board side. Accordingly, a data processing burden imposed on each panel control circuit of the plurality of electroluminescent panels may be alleviated.

In the display module, each panel control board of the plurality of panel assemblies includes a storage unit in which luminance correction data for correcting deviation of luminance of each electroluminescent panel are stored, and, at the time of power-on, the luminance of each electroluminescent panel is automatically adjusted by using the luminance correction data. With this configuration, a high quality display with no deviation of luminance between the plurality of electroluminescent panels can be realized.

In the display module, the image control board includes a storage unit in which luminance correction data for correcting deviation of luminance of each electroluminescent panel are stored. With this configuration, the display module may be simplified in size and its product costs may be reduced.

In the display module, each panel control circuit of the plurality of panel assemblies includes a plurality of output terminals for outputting signals to display the display image data individually output from the image processing circuit on each electroluminescent panel, and the plurality of output terminals is electrically connected to a plurality of wiring lines of the electroluminescent panel via a plurality of wiring lines on a flexible wiring board on which a driver IC for driving the electroluminescent panel is mounted. With this configuration, electroluminescent panels with higher precision can be realized.

In the display module, the image control board includes a plurality of output terminals to which the plurality of panel assemblies is electrically connected, for correspondingly outputting the plurality of display image data, and different display image data are displayed on each electroluminescent panel on the basis of the display image data output from the plurality of output terminals. With this configuration, by connecting the plurality of panel assemblies to the plurality of output terminals of the image control board, respectively, image data of the different type can be simultaneously displayed by the plurality of electroluminescent panels. In addition, since the number of displayable electroluminescent panels may be increased only by increasing the number of output terminals, when the electroluminescent panels are mounted in a vehicle, part standardization in various kinds of vehicles can be achieved, thus reducing product costs.

In the display module, the plurality of output terminals of the image control board includes one or more reserve output terminals for driving one or more additional electroluminescent panels added to the plurality of electroluminescent panels. With this configuration, when the electroluminescent panels are mounted on an instrument panel of a vehicle, a user may optionally modify a design of the instrument panel or add a display function.

In the display module, the image control board includes a power supply circuit for supplying power to each electroluminescent panel through the plurality of output terminals, and a plurality of input circuits input with the mobile body information data and the image data. With this configuration, by connecting apparatuses for outputting various different image data, for example, a car navigator, a television, or a video apparatus, to the plurality of input circuits, the mobile body information data and the image data input to the electroluminescent panels are changed to display different images.

In the display module, the plurality of panel assemblies are mounted on one side of a panel support member such that non-display areas around display areas of adjacent ones of the plurality of electroluminescent panels overlap with each other in plane, and the image control board is mounted on the other side of the panel support member. With this configuration, an assembly is facilitated, and hence, a display module of a mobile body can be realized with low costs.

In the display module, each panel control circuit of the plurality of panel assemblies and the image processing circuit are electrically interconnected via a plurality of connection cables passing through a plurality of cable insertion holes provided in the panel support member. With this configuration, an operation of integrating the plurality of panel assemblies and the image control board via the panel support member and an operation of electrically connecting each panel control circuit and circuits on the image control board can be performed with ease.

According to another aspect of the invention, a display module of a mobile body includes a panel unit including a plurality of panel assemblies each having an electroluminescent panel, and an image control unit for preparing a plurality of display image data on the basis of mobile body information data and image data, the image control unit including a plurality of output terminals for outputting the display image data. Each of the plurality of panel assemblies is electrically connected to a corresponding one of the plurality of output terminals, and different display image data are displayed on each electroluminescent panel on the basis of the display image data output from the plurality of output terminals.

With this configuration, images of the different type can be displayed simultaneously by each of the plurality of electroluminescent panels. In addition, various image data may be changed to display different images by each of the plurality of electroluminescent panels. In addition, wasteful power consumption of each panel may be reduced, while increasing a data transfer rate. In addition, a percentage of the number of available pixels increases. In addition, yield of the electroluminescent panels increases. In addition, since each panel is the electroluminescent panel, contrast is high and display with good visibility is possible. Accordingly, with the reduction of power consumption, the increase of the data transfer rate and the increase of the yield, a display module of a mobile body enabling display of different images can be realized.

According to yet another aspect, the invention provides a panel unit for use in a display module of a mobile body. In the panel unit, each of the plurality of panel assemblies includes a panel control board provided with a panel control circuit for displaying the plurality of display image data prepared on the basis of the mobile body information data and the image data on each electroluminescent panel. With this configuration, the plurality of panel assemblies can simultaneously display the mobile body information data, such as the car speed or the engine revolution number, and the image data, such as the map information of the car navigator, by the plurality of electroluminescent panels.

In the panel unit, each panel control board of the plurality of panel assemblies includes a storage unit in which luminance correction data for correcting deviation of luminance of each electroluminescent panel are stored. With this configuration, a high quality display with no deviation of luminance between the plurality of electroluminescent panels can be realized.

According to yet another aspect, the invention provides an image control unit for use in a display module of a mobile body. The image control unit includes an image control board provided with an image processing circuit for preparing the plurality of display image data on the basis of the mobile body information data and the image data to be input and outputting the prepared display image data to each panel control circuit of the plurality of panel assemblies. With this configuration, a high quality display with no deviation of luminance between the plurality of electroluminescent panels can be realized.

In the image control unit, the image control board includes a power supply circuit for supplying power to each electroluminescent panel through the plurality of output terminals, and a plurality of input circuits input with the mobile body information data and the image data. With this configuration, by connecting apparatuses for outputting various different image data, for example, a car navigator, a television, or a video apparatus, to the plurality of input circuits, the mobile body information data and the image data input to the electroluminescent panels are changed to display different images.

In the image control unit, the image control board includes a storage unit in which the luminance correction data for correcting deviation of luminance of each electroluminescent panel are stored. With this configuration, the display module may be simplified in size and its product costs may be reduced.

### BRIEF DESCRIPTION OF THE DRAWINGS

The invention will be described with reference to the accompanying drawings, wherein like numbers reference like elements.

FIG. 1 is a block diagram illustrating a display module of a mobile body according to an embodiment of the invention.

FIG. 2 is a block diagram illustrating a panel assembly used in the display panel of FIG. 1.

FIGS. 3A and 3B are circuit diagrams illustrating a pixel circuit and a timing chart illustrating operation of the pixel circuit, respectively.

FIG. 4 is an exploded perspective view showing the display module of FIG. 1.

FIG. 5 is a perspective view showing the panel assembly used in the display module of FIG. 1.

FIG. 6 is a perspective view showing the inside of a vehicle in which the display module of FIG. 1 is mounted.

FIG. 7 is a plan view showing a display state of the display module of FIG. 1.

FIG. 8 is a block diagram illustrating another example of the display module of the mobile body.

### DESCRIPTION OF EXEMPLARY EMBODIMENTS

Hereinafter, an exemplary embodiment of the invention will be described with reference to the accompanying drawings.

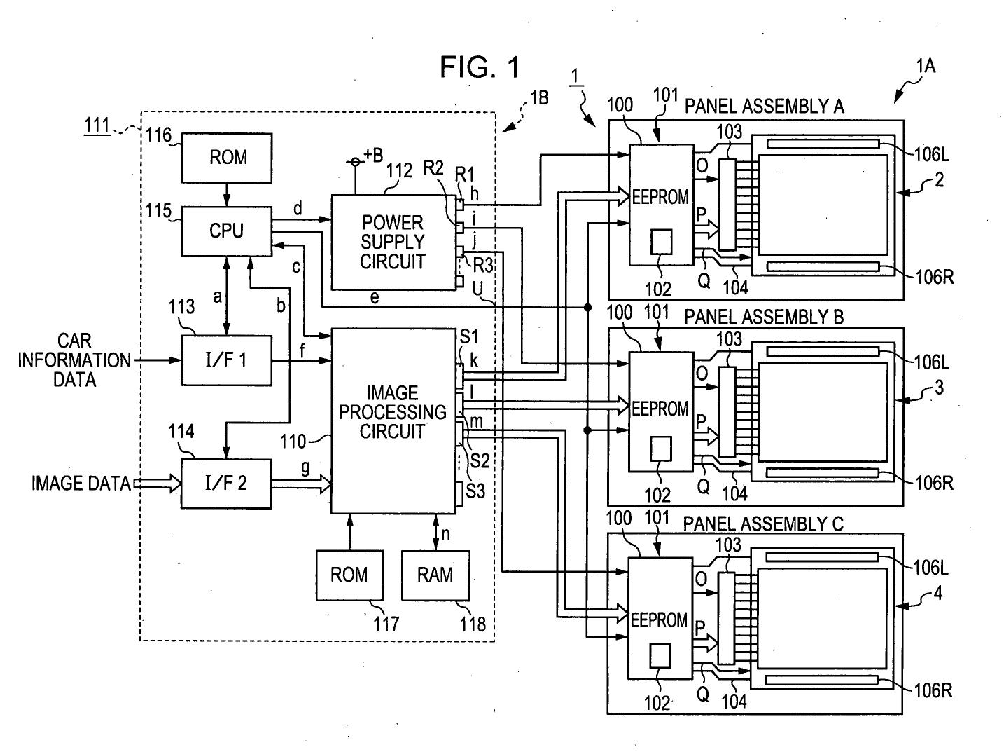

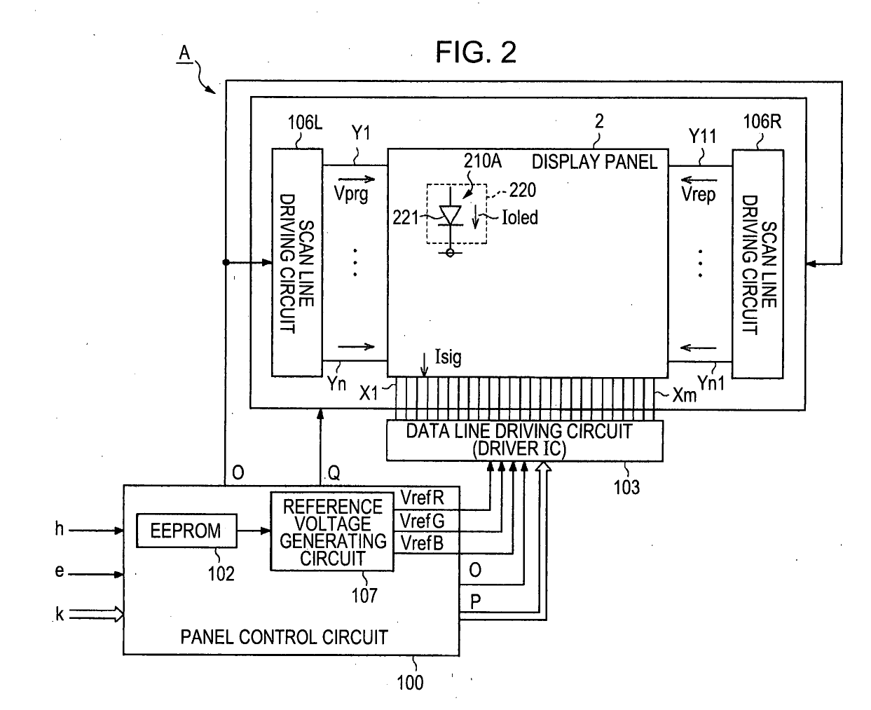

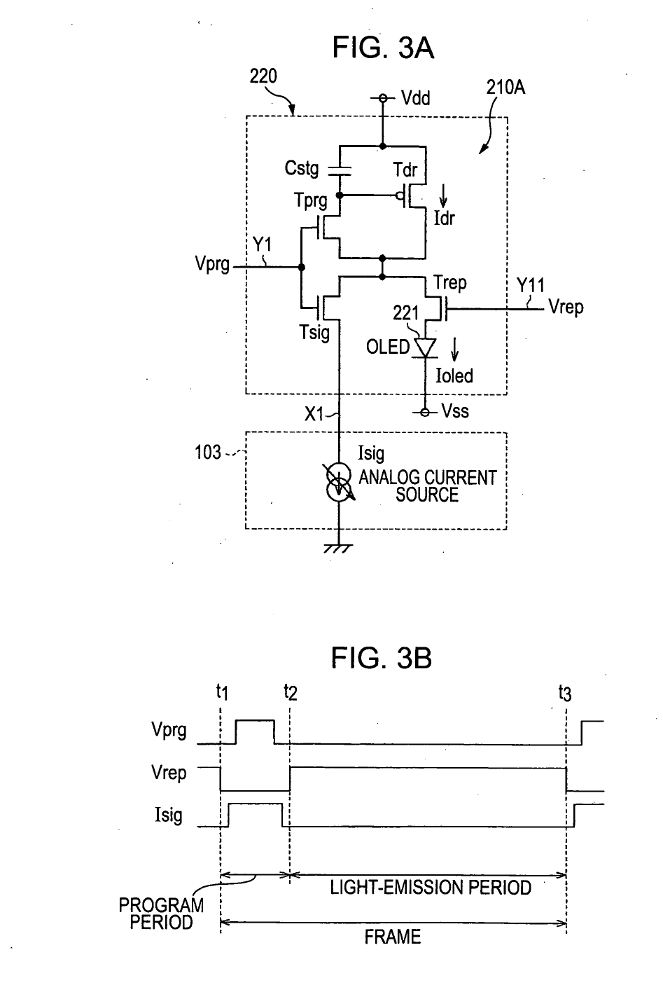

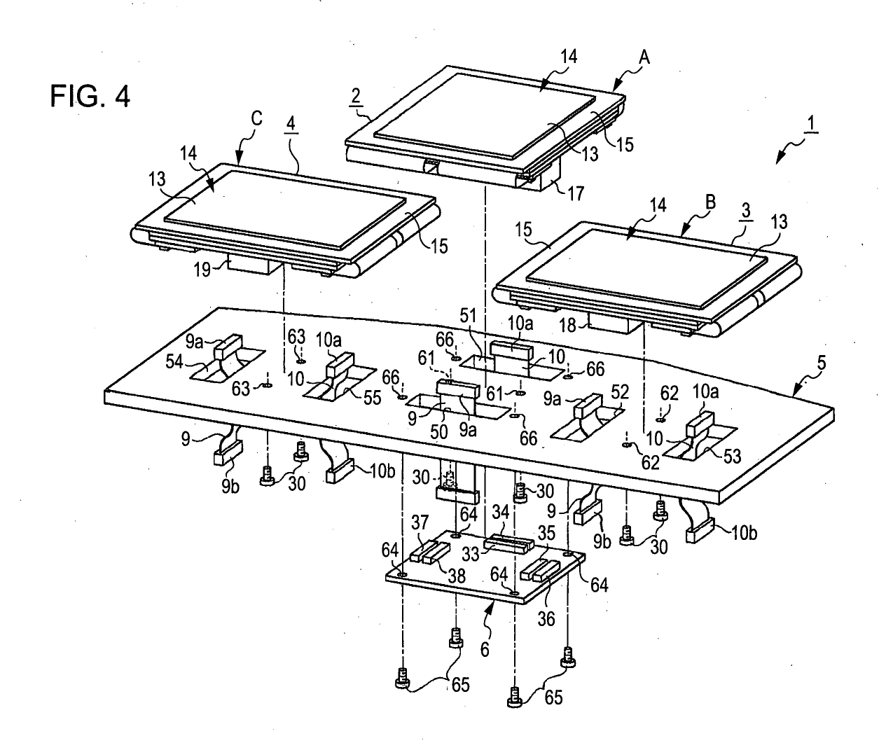

FIG. 1 shows an overall electrical configuration of a display module of a mobile body according to an embodiment of the invention. FIG. 2 shows a panel assembly used in the display panel and FIG. 3A shows a pixel circuit. FIG. 4 shows an example of an overall configuration of the display module.

As shown in FIG. 1, a display module 1 of the mobile body includes three panel assemblies A, B and C having a plurality (3) of organic electroluminescent (EL) panels 2, 3 and 4 as one example of EL panels, respectively.

In this embodiment, the display module 1 of the mobile body includes a panel unit 1A having the three panel assemblies A, B and C having the three organic EL panels 2, 3 and 4, respectively, and an image control unit 1B. The image control unit 1B prepares a plurality of display image data based on car information data and image data as mobile body information data and has a plurality of output ports R1, R2, R3, . . . , S1, S2, S3, . . . , and U as a plurality of output terminals which output the plurality of display image data. In the display module 1 of the mobile body, the panel assemblies A, B and C are electrically connected to the plurality of output ports of the image control unit 1B, respectively, and different images are displayed on the organic EL panels 2, 3 and 4 in accordance with the plurality of display image data output from the plurality of output ports.

In addition, in the display module 1 of the mobile body, as one display example, a speedometer indicating a speed of a vehicle as the mobile body is displayed on the organic EL panel 2, a tachometer indicating the number of revolutions of an engine of the vehicle is displayed on the organic EL panel 3, and map information of a car navigator is displayed on the organic EL panel 4, as shown in FIG. 7.

Electrical Configuration of Panel Assemblies

Next, an electrical configuration of each of the panel assemblies A, B and C will be described with reference to FIGS. 1 and 2.

Each of the panel assemblies A, B and C includes a panel control board 101 provided with a panel control circuit 100 for displaying an image on each organic EL panel 2, 3 and 4 using the plurality of display image data prepared in accordance with the car information data and the image data. In this embodiment, since an image processing circuit for processing an image related to the car information data and the image data or a power supply circuit is provided in the image control unit 1B, the panel control circuit 100 displays the image on each organic EL panel 2, 3 and 4 using the plurality of display image data transmitted from the image control unit 1B.

The panel control circuit 100 of each of the panel assemblies A, B and C has an EEPROM 102 as storage means in which luminance correction data for correcting deviation of luminance of each organic EL panel 2, 3 and 4 are stored. The display module 1 of the mobile body is configured to automatically adjust the luminance of each organic EL panel by using the luminance correction data stored in the EEPROM 102 at the time of power-on.

In addition, each panel control circuit 100 has a plurality of output terminals which output a control signal O, drive data P, and panel power Q as signals for displaying an image on each organic EL panel 2, 3 and 4 by using the plurality of display image data transmitted from the image control unit 1B. The plurality of output terminals (not shown) is electrically connected to a plurality of wiring lines (a plurality of data lines or a plurality of power lines) of each organic EL panel 2, 3 and 4 via a plurality of wiring lines on a flexible wiring board 104 on which a driver IC 103 for driving each organic EL panel 2, 3 and 4 is mounted.

The driver IC 103 is configured as a data line driving circuit for driving the plurality of data lines of each organic EL panel 2, 3 and 4, which will be described later. The control signal O is a signal for controlling a scan line driving circuit, which will be described later, or the driver IC 103 (the data line driving circuit). In addition, the drive data P are pixel data of each pixel (for red, green and blue), which will be described later, for example, digital gray scale data of 8 bits.

The flexible wiring board 104 is configured as a flexible printed circuit (FPC), for example. On the flexible wiring board 104 are formed a plurality of input side wiring lines (not shown) connecting the plurality of output terminals of each panel control circuit 100 and a plurality of input side terminals of the driver IC 103, and a plurality of output side wiring lines (not shown) connecting the plurality of output terminals of the driver IC 103 and a plurality of data lines, scan lines, power lines, etc. of each organic EL panel 2, 3 and 4.

Electrical Configuration of Organic EL Panel

Next, an electrical configuration of an organic EL display apparatus including the organic EL panels 2, 3 and 4 and the panel control circuit 100 in each of the panel assemblies A, B and C will be described with reference to FIGS. 1 to 3. The organic EL display apparatus of each of the panel assemblies A, B and C has the organic EL panel 2, 3 and 4 of the same configuration, and therefore, an electrical configuration of the organic EL display apparatus of only the panel assembly A is described and explanation of the organic EL panels 3 and 4 of other panel assemblies B and C will be omitted.

The organic EL display apparatus of the panel assembly A adopts a current driving system (current program system) of a current introduction-type. The organic EL display apparatus includes the organic EL panel 2, two left and right scan driving circuits 106L and 106R formed on the organic EL panel 2, the driver IC 103 as a data line driving circuit, and the panel control circuit 100.

As shown in FIG. 2, the organic EL panel 2 has a plurality of pixels 210A arranged in n rows and m columns in correspondence with intersections of n first scan lines Y1 to Yn (n is an integer) extending in a row direction and m data lines X1 to Xm (m is the integer) extending in column direction. In addition, the organic EL panel 2 has n second scan lines Y11 to Yn1 extending in the row direction. The plurality of pixels 210A are configured such that, for example, pixels for R (red), pixels for G (green) and pixels for B (blue) are arranged in an order of R, G and B.

The scan line driving circuit 106L generates and outputs program period select signals Vprg (see FIGS. 3A and 3B) of an H (high) level in order at a timing according to a synchronization signal or clock signal input as the control signal O, and selects the first scan lines Y1 to Yn in order of one-by-one by means of a line-sequential scan. FIG. 3B shows only a program period (a period from a point t1 to a point t2) that a program period select signal Vprg is output to a first scan line Y1 at a first row among the first-scan lines Y1 to Yn.

The scan line driving circuit 106R generates and outputs light-emission period select signals Vrep (see FIG. 3B) of an H (high) level in order at a timing according to a synchronization signal or clock signal input as the control signal O, and selects the second scan lines Y11 to Yn1 in order of one-by-one by means of a line-sequential scan. FIG. 3B shows only a light-emission period (a period from a point t2 to a point t3) that a light-emission period select signal Vrep of the H level is output to a second scan line Y11 at a first row among the second scan lines Y11 to Yn1.

In addition, the driver IC 103 supplies program signal current Isig (see FIG. 3B) concurrently to each pixel circuit 220 connected to one selected first scan line during the program period via the data lines X1 to Xm.

Each program signal current Isig is a current signal derived from a D-A conversion of pixel data of each pixel for red, green and blue, which is digital gray scale data of n bits for gray scale representation, in the driver IC. In this example, the pixel data of each pixel 210A are digital gray scale data representing brightness of each pixel as a binary number of 8 bits and obtain gray scales of 256 steps between 0 and 255.

The driver IC 103 includes a data writing circuit (sampling circuit) for writing the program signal current Isig in each pixel circuit 220 via the data lines X1 to Xm, a shift register for controlling an operation timing of the data writing circuit, a latch circuit, a digital/analog converter, etc. The latch circuit stores the pixel data of each pixel in a data memory provided for each pixel to hold image data of one line. The latch circuit is configured such that the pixel data stored in each data memory are concurrently read and output to the digital/analog converter (not shown) in the driver IC 103 during the program period.

Each pixel circuit 220 of the pixel for red, green and blue, as described above, has an organic EL element (see FIG. 3A) as an electroluminescent element in which red, green and blue light is emitted from light-emitting layers made of an organic semiconductor material, respectively. Each pixel circuit 220 has the same circuit configuration except the point that light emitted from respective organic EL elements 221 has different colors.

Now, the configuration of the pixel circuit 220 will be described with reference to FIG. 3A.

The pixel circuit 220 has a driving transistor Tdr, a transistor for program Tprg, a select transistor at program Tsig, a select transistor at light-emission Trep and a storage capacitance Cstg. Further, the driving transistor Tdr is composed of a P channel TFT. The transistor for program Tprg, the select transistor at program Tsig, the select transistor at light-emission Trep are each composed of an N channel TFT.

A drain of the driving transistor Tdr is connected to an anode of the organic EL element 221 whose cathode is grounded, via the select transistor at light-emission Trep. In addition, the drain of the driving transistor Tdr is connected to one data line (a data line X1 in FIG. 3A) via the select transistor at program Tsig. In addition, a source of the driving transistor Tdr is connected to a high potential power source Vdd. In addition, a gate of the driving transistor Tdr is connected to a first electrode of the storage capacitance Cstg whose second electrode is connected to the high potential power source Vdd. The transistor for program Tprg is connected between the gate and drain of the driving transistor Tdr.

A gate of the select transistor at program Tsig and a gate of the transistor for program Tprg are connected to one first scan line (a first scan line Y1 in FIG. 3A). In addition, the select transistor at program Tsig and the transistor for program Tprg are turned on in response to the program period select signal Vprg of H level from the first scan line Y1 and are turned off in response to the program period select signal Vprg of L level. In this embodiment, when the select transistor at program Tsig and the transistor for program Tprg are turned on, the program signal current Isig is applied to the data line X1.

A gate of the select transistor at light-emission Trep is connected to one second scan line (a second scan line Y11 in FIG. 3A). In addition, the select transistor at light-emission Trep is turned on in response to the light-emission period select signal Vrep of H level from the second scan line Y11 and is turned off in response to the light-emission period select signal Vrep of L level. When the select transistor at light-emission Trep is turned on, driving transistor supply current Idr based on the turn-on state of the driving transistor Tdr is supplied to the organic EL element 221 as OLED supply current Ioled.

Next, operation of each pixel circuit 220 will be described in brief with reference to FIG. 3B.

1. Program Period

Now, when the program period select signal Vprg of H level is supplied from the first scan line Y1, the transistor for program Tprg and the select transistor at program Tsig are turned on. At this time, the light-emission period select signal Vrep of L level is supplied from the second scan line Y11 and the select transistor at light-emission Trep is turned off. At this time, the program signal current Isig is supplied to the data line X1. In addition, when the transistor for program Tprg is turned on, the driving transistor Tdr is diode-coupled. As a result, the program signal current Isig flows along a path of the driving transistor Tdr ->the select transistor at program Tsig ->the data line X1. At this time, electrical charges corresponding to a potential of the gate of the driving transistor Tdr are accumulated in the storage capacitance Cstg.

2. Light-Emission Period

In this state, when the program period select signal Vprg goes to L level and the light-emission period select signal V rep goes to H level, the transistor for program Tprg and the select transistor at program Tsig are turned off and the select transistor at light-emission Trep is turned on. At this time, since the accumulating state of electrical charges of the storage capacitance Cstg is not varied, the potential of the gate of the driving transistor Tdr is held at a voltage when the program signal current Isig flows. Accordingly, the driving transistor supply current Idr (OLED supply current Ioled) having a magnitude depending on a gate voltage of the driving transistor Tdr flows between the source and drain of the driving transistor Tdr. More particularly, the OLED supply current Ioled flows along a path of the driving transistor Tdr ->the select transistor at light-emission Trep ->the organic EL element 221. Accordingly, the organic EL element 221 emits light with luminance depending on the OLED supply current Ioled (program signal current Isig).

When such an operation is performed in order in each pixel circuit 220 connected to the first scan lines Y2 to Yn, display of one frame is completed.

In addition, the panel control circuit 100 provided in the panel control board 102 of the panel assembly A has the EEPROM 102 and a reference voltage generating circuit 107. In the EEPROM 102 are stored luminance correction data for correcting deviation of luminance of each organic EL panel and adjusting luminance of each organic panel to emit light with the same luminance by the luminance data having the same gray scale. In addition, in the EEPROM 102 are stored parameters for initializing the driver IC 103, for example, data for setting a frame frequency in each organic panel 2, 3 and 4.

In this example, in order to adjust the luminance of each organic EL panel 2, 3 and 4, at the time of power-on, for example when a vehicle is powered on by a key manipulation, a reference voltage of the digital/analog converter in the driver IC 103 is corrected for each pixel for red, green and blue by the luminance correction data stored in the EEPROM 102. Accordingly, the reference voltage generating circuit 107 generates reference voltages VrefR, VrefG and VrefB for each pixel for red, green and blue, which are derived from the correction of the reference voltage of the digital/analog converter by the luminance correction data at the time of power-on, and outputs the generated reference voltages to the driver IC 103.

Electrical Configuration of Image Control Unit

Next, an electrical configuration of the image control unit 1B will be described in detail with reference to FIG. 1. The display module 1 of the mobile body displays scales 91, numbers 92 and a pointer 93 of a speedometer indicating, as an analog-basis, a car speed through the central organic EL panel 2, as shown in FIG. 7. In addition, scales 94, numbers 95 and a pointer 96 of a tachometer indicating, as the analog-basis, the number of revolutions of an engine are displayed through the right side organic EL panel 3, and an image 97 of map information of a car navigator is displayed through the left side organic EL panel 4. In addition, an image of a television or an image of a DVD apparatus may be displayed through the organic EL panel 4.

In this example, the display module 1 of the mobile body has one image control unit 1B for three organic EL panels 2, 3 and 4.

The image control unit 1B has an image control board 111 provided with an image processing circuit 110 for preparing a plurality of display image data based on the input car information data and image data and outputting the prepared display image data to each panel control circuit 100 of the three panel assemblies A, B and C.

In addition, on the image control board 111 of the image control unit 1B are provided a power supply circuit 112 for supplying power to each EL panel 2, 3 and 4 through the plurality of output ports R1, R2 and R3, and a plurality of input circuits (interfaces I/F1 and I/FF2) 113 and 114 input with the car information data and image data, respectively. In addition, on the image control board 111 are provided a CPU 115 for generally controlling the image processing circuit 110, the power supply circuit 112 and the input circuits 113 and 114, a ROM 116 in which various control programs are stored, a ROM 117 in which various image data used for image processing are stored, and a RAM 118 for image processing.

In the ROM 117, background data for displaying the scales 91 and the numbers 92 of the speedometer, and background data for displaying the scales 94 and the numbers 95 of the tachometer are stored. In addition, in the ROM 117 are stored image data for preparing an image of the pointer 93 overlapping the scales 91 and the numbers 92 of the speedometer, image data for preparing an image of the pointer 96 overlapping the scales 94 and the numbers 95 of the tachometer, etc. A method of overlapping the pointer 93 or the pointer 96 with the respective background images may be implemented according to any one of the following two cases.

A plurality of pointer data having different positions by a predetermined angle (two kinds of pointer data for the pointer 93 and pointer data for the pointer 96) are stored in the ROM 117, and the pointer data according to a car speed or the number of revolutions of an engine are read, and the display image data of the speedometer and the tachometer are prepared by adding the read pointer data and the background data.

Image data of the pointer 93 and the pointer 96 at angular positions according to car speed data and the number of revolutions of an engine are prepared, and the display image data of the speedometer and the tachometer are prepared by adding the prepared image data of the pointers and the background data.

The input circuit 113 is input with the car speed data for displaying the speedometer through the organic EL panel 2 and the engine revolution number data for displaying the tachometer through the organic EL panel 3. The car speed data sensed by a car speed sensor and the engine revolution number data sensed by an engine revolution number sensor are successively sent from an in-vehicle ECU (electronic Control Unit) through an in-vehicle network. As an in-vehicle network protocol, a CAN (Controller Area Network), FlexRay, etc. may be used, for example.

The input circuit 114 is input with the image data (for RGB) such as map information from an in-vehicle navigator. In this example, since a clock (synchronization signal) along with the image data is input to the input circuit 114, scans in the organic EL panels 2, 3 and 4 are synchronized based on the synchronization signal. In addition, based on the clock (synchronization signal) received from the organic EL panels 2, 3 and 4, the image data may be transferred from the image control unit 1B to each of the panel assemblies A, B and C, and the organic EL panels 2, 3 and 4 may be scanned. In addition, the input circuit 114 may be input with image data from other systems such as a television, video apparatus, etc., or image data from a storage device such as an HDD, DVD, etc.

In the image control unit 1B shown in FIG. 1, reference symbol a denotes a car information data control signal, reference symbol b denotes an image data control signal, reference symbol c denotes an image processing circuit control signal, reference symbol d denotes a power supply circuit control signal, reference symbol e denotes a panel assembly control signal, reference symbol f denotes the car information data, and reference symbol g denotes the image data. In addition, reference symbol h denotes a power signal to the panel assembly A, reference symbol i denotes a power signal to the panel assembly B, reference symbol j denotes a power signal to the panel assembly C, reference symbol k denotes image data to the panel assembly A, reference symbol l denotes image data to the panel assembly B, and reference symbol m denotes image data to the panel assembly C. In addition, reference symbol n denotes a control signal of the RAM 118.

The CPU 115 performs a control of transferring the car information data f (the car speed data and the engine revolution number data) successively input to the input circuit 113 by the car information data control signal a to the image processing circuit 110. In addition, the CPU 115 performs a control of transferring the image data g input to the input circuit 114 by the image data control signal b to the image processing circuit 110. In addition, the CPU 115 performs a control of outputting the power signals h, i and j from the respective output ports R1, R2 and R3 of the power supply circuit 112 to the respective panel assemblies A, B and C by the power supply circuit control signal d. In addition, the CPU 115 performs a control of outputting the image data k, l and m from the respective output ports S1, S2 and S3 of the image processing circuit 110 to the respective panel assemblies A, B and C by the image processing circuit control signal c. In addition, the CPU 115 performs a control of outputting the panel assembly control signal e to each of the panel assemblies A, B and C.

The above-configured display module 1 of the mobile body displays the speedometer indicating the car speed according to the car speed data input to the input circuit 113 on the organic EL panel 2, while displaying the tachometer indicating the engine revolution number according to the engine revolution number data input to the input circuit 114 on the organic EL panel 3 (see FIG. 7). In addition, when the image data such as the map information from the car navigator are input to the input circuit 114, the display module 1 of the mobile body displays the image data on the organic EL panel 4 (see FIG. 7).

Next, an exemplary configuration in which the display module 1 of the mobile body having the above-described electrical configuration is contained in an instrument panel of a vehicle and an exemplary configuration of the panel assemblies A, B and C used in the display module 1 will be described with reference to FIGS. 4 to 7.

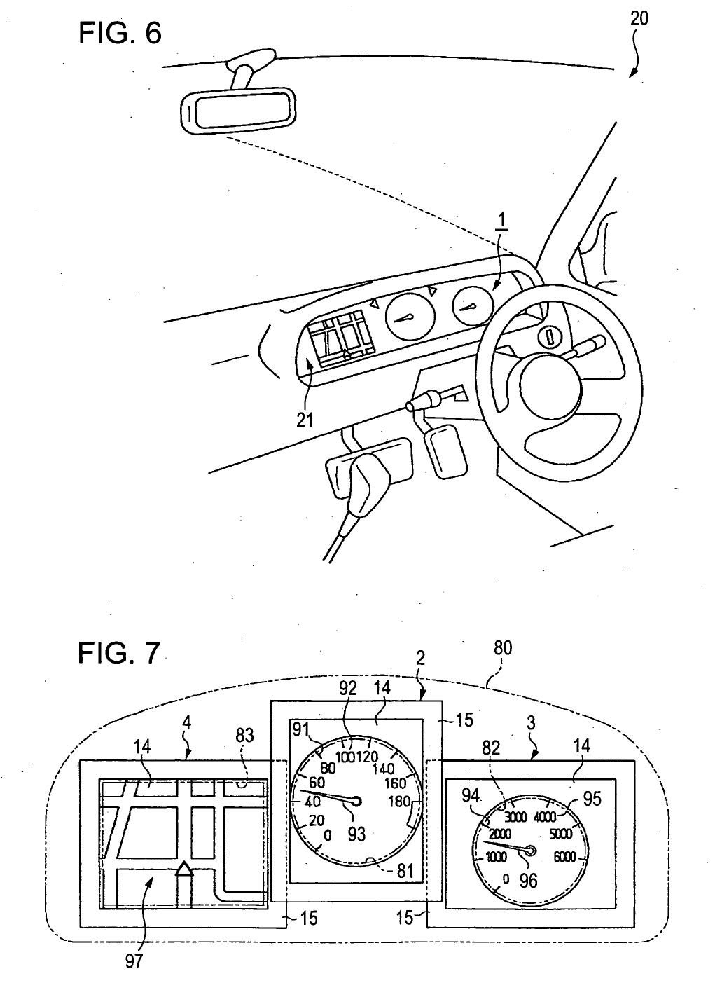

As shown in FIG. 6, the display module 1 of the mobile body is mounted on an instrument panel 21 of a vehicle 20. As shown in FIG. 4, the display module 1 of the mobile body is mounted in a manner that three panel assemblies A, B and C having the organic EL panels 2, 3 and 4, respectively, are arranged on one base plate 5 as a panel support member.

As shown in FIGS. 4 and 7, the three panel assemblies A, B and C are mounted on one side (the top side in FIG. 4) of the base plate 5 such that non-display areas 15 around display areas 14 of adjacent ones of the three organic EL panels 2, 3 and 4 overlap with each other in plane. In the mean time, the image control board 6 of the image control unit 1B is mounted on the other side (the bottom side in FIG. 4) of the base plate 5. In addition, the image control board 6 shown in FIG. 4 corresponds to the image control board 111 shown in FIG. 1.

Since the panel assemblies A, B and C have the same configuration, an explanation will be hereinafter focused on the configuration of the panel assembly A.

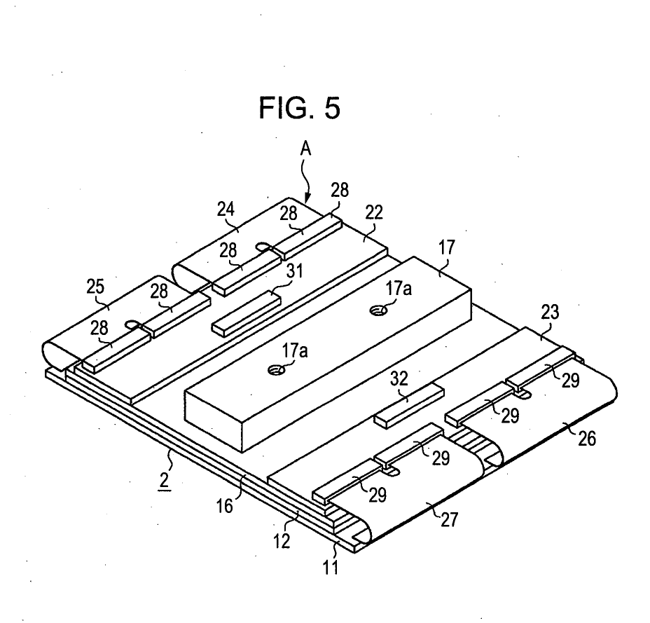

As shown in FIG. 5, the organic EL panel 2 of the panel assembly A includes a light-emitting element board 11, a sealing board 12, a panel base plate 16 fixed on a surface of the sealing board 12, and a mount base 17 fixed in the about center of the panel base plate 16. In addition, the panel assembly A includes two left and right panel control boards 22 and 23, and four flexible wiring boards 24, 25, 26 and 27 are arranged in both left and right sides of the organic EL panel 2 two at a time.

Here, two panel control boards 22 and 23 correspond to one panel control board 101 shown in FIG. 1. Each of the panel control boards 22 and 23 is provided with the panel control circuit 100. In addition, the four flexible wiring boards 24 to 27 correspond to the flexible wiring board 104 shown in FIG. 1. The driver IC 103 is mounted on each flexible wiring board 24 to 27, like the flexible wiring board 104. In addition, at a light-emission (surface) side is fixed a circular deflecting plate 13 (see FIG. 4) for suppressing incident light from being reflected on the light-emission surface.

The panel control circuit 100 of each of the panel control boards 22 and 23 in the three panel assemblies A, B and C is electrically connected to a circuit (the image processing circuit 110, the power supply circuit 112, etc) at one image control board 6 side via two connection cables 9 and 10. In order to obtain such electrical connection, one connector 9a and 10a of each connection cable 9 and 10 is connected to connectors 31 and 32 of the panel control boards 22 and 23, and the other connector 9b and 10b is connected to connectors 35 and 36 provided in the image control board 6.

The base plate 5 is mounted on the instrument panel 21 of the vehicle 20 shown in FIG. 6. The base plate 5 is a plate having a flat panel-mounted plane to which the three organic EL panels 2 to 4 are fixed. The three organic EL panels 2 to 4 are fixed to the panel-mounted plane of the base plate 5 via mount bases 17, 18 and 19 of the panel assemblies A, B and C by two fixation screws 30 and 30 (see FIG. 4).

Like this, since the base plate 5 has the flat panel-mounted plane, heights of the organic EL panels 2, 3 and 4 from the panel-mounted plane may be altered by making only thickness of the mount bases 17, 18 and 19 of the panel assemblies A, B and C different. Here, by making the thickness of the mount base 17 of the central organic EL panel 2 larger than the thickness of the mount bases 18 and 19 of the left and right organic EL panels 3 and 4, the heights of the organic EL panels 2, 3 and 4 from the panel-mounted plane may be altered such that the non-display areas 15 of adjacent panels overlap with each other in plane.

Next, an assembly order of the display module 1 of the mobile body will be described with reference to FIG. 4.

First, when the organic EL panel 2 is mounted on the base plate 5, the two fixation screws 30 pass through two through holes 61 provided in the central portion of the base plate 5, respectively, and then are screwed on two screw holes 17a provided in the mount base 17 of the organic EL panel 2, respectively. At this time, the connection cables 9 and 10 whose connectors 9a and 10a are connected to the organic EL panel 2 pass through horizontally-elongated cable insertion holes 50 and 51 of the base plate 5.

Next, when the right organic EL panel 3 is mounted on the base plate 5, the two fixation screws 30 pass through two through holes 62 provided in the right side of the base plate 5, respectively, and then are screwed on two screw holes (such as the screw holes 17a) provided in the mount base 18 of the organic EL panel 3, respectively. At this time, the connection cables 9 and 10 whose connectors 9a and 10a are connected to the organic EL panel 3 pass through vertically-elongated cable insertion holes 52 and 53 of the base plate 5.

Next, when the left organic EL panel 4 is mounted on the base plate 5, the two fixation screws 30 pass through two through holes 63 provided in the left side of the base plate 5, respectively, and then are screwed on two screw holes (such as the screw holes 17a) provided in the mount base 19 of the organic EL panel 4, respectively. At this time, the connection cables 9 and 10 whose connectors 9a and 10a are connected to the organic EL panel 4 pass through vertically-elongated cable insertion holes 54 and 55 of the base plate 5.

Next, the connectors 9b and 10b of the connection cables 9 and 10 whose connectors 9a and 10a are connected to the organic EL panel 2 are connected to connectors 33 and 34 of the image control board 6. Likewise, the connectors 9b and 10b of the connection cables 9 and 10 whose connectors 9a and 10a are connected to the organic EL panel 3 are connected to the connectors 35 and 36 of the image control board 6, and the connectors 9b and 10b of the connection cables 9 and 10 whose connectors 9a and 10a are connected to the organic EL panel 4 are connected to connectors 37 and 38 of the image control board 6.

Thereafter, when the image control board 6 is mounted on the base plate 5, four fixation screws 65 pass through four through holes 64 provided in four corners of the image control board 6, respectively, and then are screwed on four screw holes 66 provided in the central portion of the base plate 5, respectively. In addition, when the image control board 6 is fixed by the fixation screws 65, a spacer (not shown) is disposed between the base plate 5 and the image control board 6 such that parts on the base plate 5 do not interfere with parts on the image control board 6.

The base plate 5 of the display module 1 of the mobile body, which is assembled according to the above-mentioned procedure, is mounted on the instrument panel 21 of the vehicle 20 shown in FIG. 6. FIG. 7 shows a state where a panel cover 80 made of resin, which is denoted by a chain double-dashed line, is mounted on a surface of the display module 1 of the mobile body mounted on the instrument panel 21. In the panel cover 80 are provided a circular opening 81 for the speedometer displayed in the display area 14 of the central organic EL panel 2, a circular opening 82 for the tachometer displayed in the display area 14 of the right organic EL panel 3, and a rectangular opening 83 for image displayed in the left organic EL panel 4.

The above-described embodiment shows the following operations and effects.

Since the display module 1 of the mobile body has the three panel assemblies A, B and C having the organic EL panels 2, 3 and 4, respectively, and displays one of the car information data and the image data on the respective organic EL panels 2, 3 and 4, different images can be displayed simultaneously on the organic EL panels. In addition, various image data may be changed to display different images on the organic EL panels 2, 3 and 4. In addition, since different images are displayed on the organic EL panels 2, 3 and 4, wasteful power consumption of each panel may be reduced, while increasing a data transfer rate. In addition, a percentage of the number of available pixels increases. In addition, yield of each organic EL panel 2, 3 and 4 increases. In addition, since each panel is the organic EL panel, contrast is high and display with good visibility is possible. Accordingly, with the reduction of power consumption, the increase of the data transfer rate and the increase of the yield, a display module of a mobile body enabling display of different images can be realized.

Each of the panel assemblies A, B and C includes the panel control board 101 provided with the panel control circuit 100 for displaying an image on each organic EL panel 2, 3 and 4 using the plurality of display image data prepared based on the car information data and the image data. Accordingly, the car information data such as the car speed or the engine revolution number and the image data such as the map information of the car navigator can be simultaneously displayed on the organic EL panels 2, 3 and 4.

Each panel control board 101 of the panel assemblies A, B and C has the EEPROM 102 in which the luminance correction data for correcting deviation of luminance of each organic EL panel 2, 3 and 4 are stored, and at the time of power-on, the luminance of each organic EL panel 2, 3 and 4 is automatically adjusted using the luminance correction data. Accordingly, a high quality display with no deviation of luminance between the organic EL panels 2, 3 and 4 can be realized.

The image control board 111 is provided with the image processing circuit 110 for preparing a plurality of display image data based on the input car information data and image data and outputting the prepared display image data to each panel control circuit 100 of the panel assemblies A, B and C. Accordingly, display in each organic EL panel 2, 3 and 4 can be controlled at the image control board 11 side. Accordingly, a data processing burden imposed on each panel control circuit 100 of the organic EL panels 2, 3 and 4 may be alleviated.

Each panel control board 101 of the panel assemblies A, B and C has a plurality of output terminals for outputting signals to display images on each organic EL panel 2, 3 and 4 using the plurality of display image data output from the image processing circuit 110. The plurality of output terminals is electrically connected to a plurality of wiring lines of each organic EL panel 2, 3 and 4 via a plurality of wiring lines on the flexible wiring board 104 on which the driver IC 103 for driving each organic EL panel 2, 3 and 4 is mounted. Accordingly, organic EL panels with higher precision can be realized.

The image control board 111 has a plurality of output ports R1, R2, R3, . . . , S1, S2, S3, . . . , and U to which the panel assemblies A, B and C are electrically connected, for outputting the plurality of display image data, respectively, and displays different images on the organic EL panels 2, 3 and 4 based on the display image data output from the plurality of output terminals. Accordingly, by connecting the organic EL panels 2, 3 and 4 to the plurality of output terminals of the image control board 111, respectively, different image data can be simultaneously displayed on the organic EL panels 2, 3 and 4. In addition, since the number of displayable organic EL panels may be increased only by increasing the number of output terminals, when the organic EL panels are mounted in a vehicle, part standardization in various kinds of vehicles can be achieved, thus reducing product costs.

The image control board 111 has the power supply circuit 112 for supplying power to each EL panel 2, 3 and 4 through the plurality of output ports, and a plurality of input circuits 113 and 114 input with the car information data and image data, respectively. Accordingly, by connecting apparatuses for outputting various different image data, for example, a car navigator, a television, or a video apparatus, to the plurality of input circuits, the car information data and the image data input to the organic EL panels 2, 3 and 4 are changed to display different images.

The panel assemblies A, B and C and the image control board 6 of the image control unit 1B may be mount on the same base plate 5. Accordingly, an assembly is facilitated, and hence, a display module of a mobile body can be realized with low costs.

The panel control circuit 100 of each organic EL panel 2, 3 and 4 and circuits on the image control board 111 are electrically interconnected via the connection cables 9 and 10 passing through a plurality of cable insertion holes of the base plate 5. Accordingly, an operation of integrating the plurality of panel assemblies A, B and C and the image control unit 1B via the base plate 5 and an operation of electrically connecting each panel control circuit 100 and circuits on the image control board 111 can be performed with ease.

Further, the invention can be modified and embodied as follows.

In the above embodiment, the plurality of output terminals of the image control board 111 may be configured to include one or more reserve output terminals for driving one or more organic EL panels added to each organic EL panel 2, 3 and 4. Accordingly, when the organic EL panels are mounted on an instrument panel of a vehicle, a user may optionally modify a design of the instrument panel or add a display function.

In the above embodiment, as one example, in order to adjust the luminance of each organic EL panel 2, 3 and 4, at the time of power-on, the reference voltage of the digital/analog converter in the driver IC 103 is corrected for each pixel for red, green and blue by the luminance correction data stored in the EEPROM 102. However, the invention is not limited to this. For example, the invention may be applied to a method in which the reference voltage of each pixel 210A (in the pixel circuit shown in FIG. 3A, the high potential power source Vdd to which the source of the driving transistor Tdr is connected) is corrected for each pixel for R (red), G (green) and B (blue) by the luminance correction data. In addition, the invention may be applied to a method in which the pixel data themselves of each pixel are corrected by the luminance correction data and each organic EL panel 2, 3 and 4 is driven using the corrected image data.

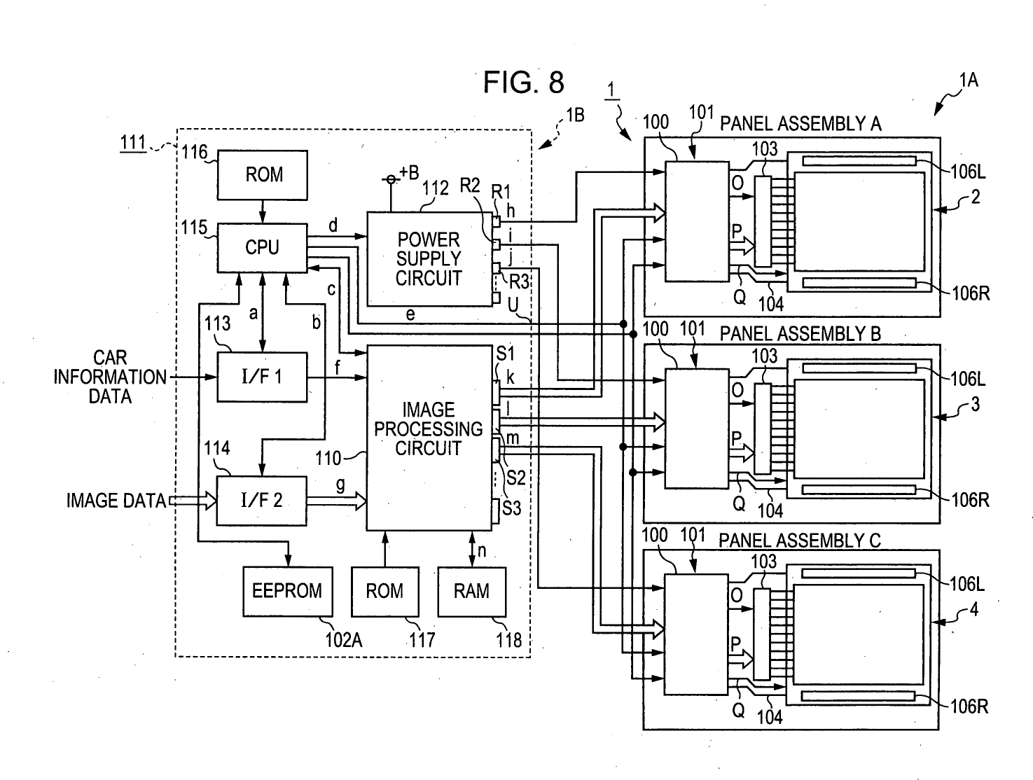

In the above embodiment, each panel control board 101 of the panel assemblies A, B and C is provided with the EEPROM 102 in which the luminance correction data for correcting the deviation of luminance of the organic EL panels 2, 3 and 4 are stored. Alternatively, as shown in FIG. 8, instead of the EEPROM 102 of each panel control board 101, a single EEPROM 102A may be provided as storage means in the image control board 111 of the image control unit 1B. In addition, the luminance correction data stored in the EEPROM 102, which is provided in the panel control board 101 of each of the panel assemblies A, B and C described in the above embodiment are collectively stored in the EEPROM 102A.

In addition, for example, at the time of power-on, the CPU 115 mounted on the image control board 111 may read the luminance correction data for each of the panels 2, 3 and 4, stored in the EEPROM 102A, and output the read luminance correction data to the reference voltage generating circuit 107 (see FIG. 2) of the panel control circuit 100 provided in the corresponding panel control board 101. Accordingly, the display module 1 of the mobile body may be simplified in size and its product costs may be reduced in that the number of the storage means (EEPROM 102A) for storing the luminance correction data of each organic EL panel 2, 3 and 4 is one.

In addition, in the EEPROM 102A may be collectively stored parameters for initialization of each driver IC 103 described in the above embodiment.

In the above embodiment, the driver IC 103 constructed as the data line driving circuit is mounted on the flexible wiring board 104. However, the invention may be applied to a structure in which the data line driving circuit is formed on the light-emitting element board 11 of each organic EL panel 2 to 4.

In the above embodiment, the number of organic EL panels is ‘3’ as one example. The invention is applicable to any display module of a mobile body using more or less than ‘3’ organic EL panels.

In the above embodiment, three organic EL panels having the same size are used. However, the invention is applicable to any display module of a mobile body using a plurality of organic EL panels having different sizes. For example, when the display module is installed in a vehicle and a speedometer is displayed on a central one of the three organic EL panels, it is preferable that the central panel becomes relatively larger and is located in an upper portion and the left and right panels become relatively smaller and are located lower than the central panel.

In the above embodiment, in adjacent ones of the three organic EL panels, the non-display areas 15 around the display areas 14 overlap with each other in plane. However, the invention is applicable to a structure in which a plurality of organic EL panels does not overlap among them.

In the above embodiment, a reserved space for additionally mounting one or more organic EL panels later is not provided in the base plate on which the plurality of organic EL panels is mounted. The invention is applicable to a structure in which the reserved space is provided in the base plate or the panel cover. By adopting such a structure, when the organic EL panels are mounted on an instrument panel of a vehicle, a user may optionally modify a design of the instrument panel or add a display function.

In the above embodiment, the organic EL panel using the organic EL element is used as an electroluminescent element. The invention is applicable to a structure in which an inorganic EL panel using an inorganic EL element is used as the electroluminescent element.

In the above embodiment, the image such as the map information of the car navigator is displayed on one of the three organic EL panels. In addition, an image of a back monitor of a vehicle may be displayed on the organic EL panel. In the end, it is possible for a user to arbitrarily select a display mode displayed on a plurality of organic EL panels.

In the above embodiment, the invention is applicable to a case where some of the plurality of organic EL panels are arranged at a location other than an instrument panel of a vehicle. For example, the invention is applicable to a case where a portion of the plurality of organic EL panels is arranged at a location at which a passenger in a back seat can view images displayed on the organic EL panels.

What is claimed is:

1. A display module of a mobile body, comprising:
a plurality of panel assemblies each having an electroluminescent panel,
wherein one of mobile body information data and image data is displayed on each electroluminescent panel of the plurality of panel assemblies.

2. The display module according to claim 1,
wherein each of the plurality of panel assemblies includes a panel control board provided with a panel control circuit for displaying a plurality of display image data prepared on the basis of the mobile body information data and the image data displayed on each electroluminescent panel.

3. The display module according to claim 2, further comprising:
an image control board provided with an image processing circuit for preparing the plurality of display image data on the basis of the mobile body information data and the image data to be input and outputting the prepared display image data to each panel control circuit of the plurality of panel assemblies.

4. The display module according to claim 2,
wherein each panel control board of the plurality of panel assemblies includes a storage unit in which luminance correction data for correcting deviation of luminance of each electroluminescent panel are stored, and, at the time of power-on, the luminance of each electroluminescent panel is automatically adjusted by using the luminance correction data.

5. The display module according to claim 3,
wherein the image control board includes a storage unit in which luminance correction data for correcting deviation of luminance of each electroluminescent panel are stored.

6. The display module according to claim 3,
wherein each panel control circuit of the plurality of panel assemblies includes a plurality of output terminals for outputting signals to display the display image data individually output from the image processing circuit on each electroluminescent panel, and the plurality of output terminals is electrically connected to a plurality of wiring lines of the electroluminescent panel via a plurality of wiring lines on a flexible wiring board on which a driver IC for driving the electroluminescent panel is mounted.

7. The display module according to claim 3,
wherein the image control board includes a plurality of output terminals to which the plurality of panel assemblies is electrically connected, for correspondingly outputting the plurality of display image data, and different display image data are displayed on each electroluminescent panel on the basis of the display image data output from the plurality of output terminals.

8. The display module according to claim 7,
wherein the plurality of output terminals of the image control board includes one or more reserve output terminals for driving one or more additional electroluminescent panels added to the plurality of electroluminescent panels.

9. The display module according to claim 7,
wherein the image control board includes a power supply circuit for supplying power to each electroluminescent panel through the plurality of output terminals, and a plurality of input circuits input with the mobile body information data and the image data.

10. The display module according to claim 3,
wherein the plurality of panel assemblies are mounted on one side of a panel support member such that non-display areas around display areas of adjacent ones of the plurality of electroluminescent panels overlap with each other in plane, and the image control board is mounted on the other side of the panel support member.

11. The display module according to claim 10,
wherein each panel control circuit of the plurality of panel assemblies and the image processing circuit are electrically interconnected via a plurality of connection cables passing through a plurality of cable insertion holes provided in the panel support member.

12. A display module of a mobile body, comprising:
a panel unit including a plurality of panel assemblies each having an electroluminescent panel; and
an image control unit for preparing a plurality of display image data on the basis of mobile body information data and image data, the image control unit including a plurality of output terminals for outputting the display image data,
wherein each of the plurality of panel assemblies is electrically connected to a corresponding one of the plurality of output terminals, and different display image data are displayed on each electroluminescent panel on the basis of the display image data output from the plurality of output terminals.

13. A panel unit for use in the display module according to claim 12,
wherein each of the plurality of panel assemblies includes a panel control board provided with a panel control circuit for displaying the plurality of display image data prepared on the basis of the mobile body information data and the image data on each electroluminescent panel.

14. The panel unit according to claim 13,
wherein each panel control board of the plurality of panel assemblies includes a storage unit in which luminance correction data for correcting deviation of luminance of each electroluminescent panel are stored.

15. An image control unit for use in the display module according to claim 12, comprising:
an image control board provided with an image processing circuit for preparing the plurality of display image data on the basis of the mobile body information data and the image data to be input and outputting the prepared display image data to each panel control circuit of the plurality of panel assemblies.

16. The image control unit according to claim 15,
wherein the image control board includes a power supply circuit for supplying power to each electroluminescent panel through the plurality of output terminals, and a plurality of input circuits input with the mobile body information data and the image data.

17. The image control unit according to claim 15,
wherein the image control board includes a storage unit in which the luminance correction data for correcting deviation of luminance of each electroluminescent panel are stored.
